(19) United States
(12) Patent Application Publication
(10) Pub. No.: US 2006/0089835 A1
(43) Pub. Date: Apr. 27, 2006

(54) Automatic production of vocal recognition in interfaces for an applied field

(75) Inventors: Pascal Bisson, Paris (FR); Celestin Sedogbo, Beynes (FR); Olivier Grisvard, Palaiseau (FR); Claire Laudy, Paris (FR); Benedicte Goujon, Vanves (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: Thales, Neuilly Sur Seine (FR)

(21) Appl. No.: 10/541,192

(22) PCT Filed: Dec. 15, 2003
(86) PCT No.: PCT/EP03/51001

§ 371 Date: Jun. 30, 2005

(30) Foreign Application Priority Data
Dec. 31, 2002 (FR) 02/16902

(51) Int. Cl. G10L 15/18

(52) U.S. Cl. 704/257

(57) ABSTRACT

The device for automatic production of voice recognition interfaces comprises means for graphical input of a conceptual model, derivation means, means of providing a generic model and means of executing the grammar specific to the field of application concerned.

The present invention relates to a generic method for automatic production of voice recognition interfaces for an applied field and a device for implementing this method.

Voice recognition interfaces are used, in particular in operator-system interaction systems, which are specific cases of man-machine interfaces. An interface of this type is the means by which an operator accesses the functions included in a system or a machine. More specifically, this interface enables the operator to evaluate the status of the system through perception modalities and modify this status using action modalities. Such an interface is normally the result of consideration and design work conducted upline on the operator-system interaction, a discipline targeted on studying the relationships between a user and the system with which he interacts.

The interface of a system, for example the man-machine interface of a computer system, must be natural, powerful, intelligent (capable of adapting itself to the context), reliable, intuitive (that is, easy to understand and use), in other words, as “transparent” as possible, in order to enable the user to carry out his task without increasing his workload through activities that do not fall within his primary objective.

By using communication channels that are familiar to us, such as speech and pointing gestures, the voice interfaces are both more user-friendly and more powerful. Nevertheless, implementing them is more complicated than for traditional interfaces, graphical for example, because it entails the acquisition of multi-disciplinary knowledge, generally high level, and the deployment of complex processes for exploiting this knowledge to “intelligently” manage the dialog between the operator and the system.

Currently, the voice interfaces are produced “manually”, that is, for each new interface, all the functions of the interface need to be re-studied, without being able to use any assistance (state machines for example) to facilitate its implementation.

The subject of the present invention is a method for automating the production of voice interfaces in the easiest and simplest possible way, with the shortest possible development time and least cost.

Another subject of the present invention is a device for implementing this method, a device that is simple to use and inexpensive.

The method according to the invention is characterized by the fact that a conceptual model of the applied voice interface field is input, that a set of generic grammar rules representative of a class of applications is produced, that the different generic grammar rules whose constraints are satisfied are exemplified, that the grammar for the applied field concerned is produced from the exemplified generic grammar and from the conceptual model and that the operator-system interaction is managed.

The device for automatic production of voice interfaces according to the invention comprises conceptual model input means, derivation means, means of providing a generic model and means of executing the grammar specific to the applied field concerned.

The present invention will be better understood from reading the detailed description of an embodiment, taken as a nonlimiting example and illustrated by the appended drawing, in which:

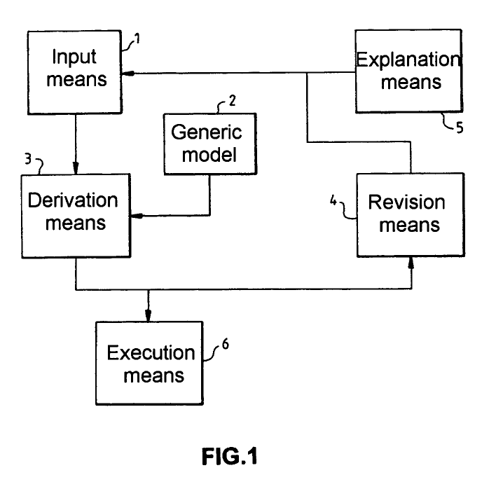

FIG. 1 is a block diagram of the main means implemented by the invention,

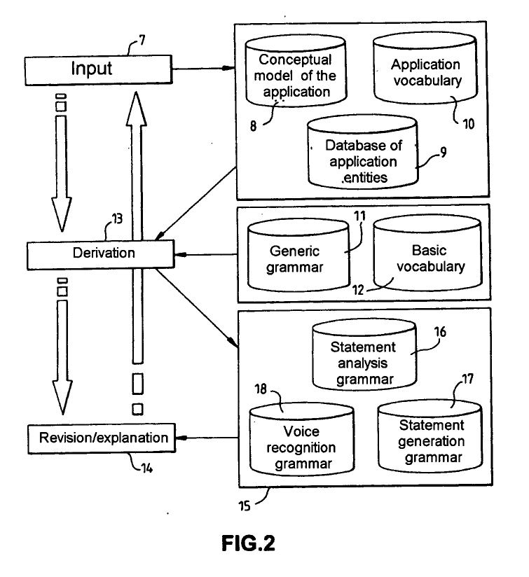

FIG. 2 is a block diagram with more detail than that of FIG. 1, and

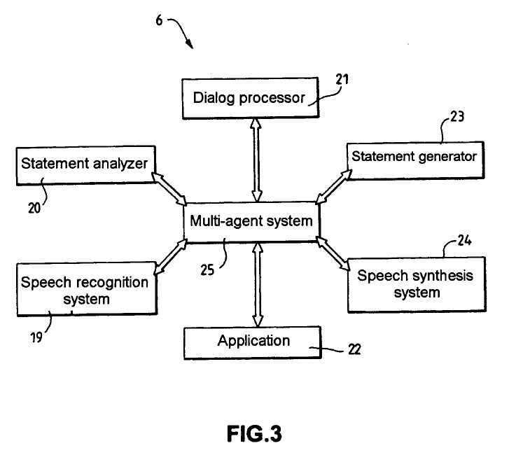

FIG. 3 is a detailed block diagram of the execution means of FIGS. 1 and 2.

FIG. 1 shows input means 1 for inputting the data describing the conceptual model for the applied field concerned and the relationships interlinking the data. The data can be, for example, in the case of the voice control used to pilot an aircraft, the terminology of all the devices and all the functions of an aircraft, as well as their different mutual relationships.

Moreover, a set 2 of grammar rules is constructed and stored, to form a generic model representing a class of applications (for the example mentioned previously, this class would be that relating to the control of vehicles in general). From the conceptual model 1 and the generic model 2, derivation means 3 automatically compute the set of resources needed to produce the desired voice interface, and from this, deduce the set of language statements liable to be processed by this interface in the context of the application concerned.

Furthermore, the device of the invention comprises revision means 4 and explanation means 5. The revision means 4 are supervised by the operator or designer of the device. Their function is to revise the data input by the operator using means 1, in order to correct terms contrary to the semantics of the application concerned and/or add new terms to enrich the grammar of the applied field. The explanation means 5 facilitate the revision of the data input by the operator by explaining the rules that were applied when generating the grammar specific to the applied field.

The execution means 6 are responsible for automatically producing the voice interface of the applied field concerned. The method of producing this interface relies on the distinction between the resources that depend on the application and which are specific resources (that is, all the concepts that make up the conceptual model input via the means 1 and the set of terms that make up the vocabulary), and the resources that do not depend on this application (generic resources), that is the syntactic rules of the grammar and all of the basic vocabulary, which are specific to the language used.

To implement this method, the designer of the voice interface needs to describe, using the input means 1, the resources specific to the application concerned, that is, the conceptual model and the vocabulary of this application. For him, this entails defining the concepts of the application that he wants to be able to have controlled by the voice, then verbalizing these concepts. This input work can be facilitated by the use of a formal model of the application concerned, provided that this model exists and is available.

When the resources specific to the application are thus acquired, the derivation means 3, which operate entirely automatically, use these specific resources and generic resources supplied by the means 2 to compute the linguistic model of the voice interface for said application. This linguistic model is made up of the grammar and the vocabulary of the sub-language dedicated to this interface. The derivation means 3 are also used to compute the set of statements of this sub-language (that is, its phraseology), as well as all the knowledge relating to the application and needed to manage the operator-system dialog.

The revision means 4 are then used by the operator to display all or some of the phraseology corresponding to his input work, in order to be able to refine this phraseology by adding, deleting or modifying. To help the operator in this task, the means 5 of producing explanations make it possible to automatically identify the conceptual and vocabulary data input by the operator from which a given characteristic of a statement or a set of statements of the sub-language produced originates.

Finally, the execution means 6 form the environment that is invoked on using this resulting voice interface, in order to validate this interface. To this end, the execution means use all of the data supplied by the input means 1 and the derivation means 3.

FIG. 2 represents an exemplary embodiment of the device for implementing the method of the invention. The operator has an input interface 7, such as a graphical interface, for entering the conceptual model 8 of the application concerned. He also has a database 9 containing the entities or concepts of the application, and a vocabulary 10 of this application. Thus, the conceptual model is composed of the entities of the application and their mutual associations, that is, the predicative relationships interlinking the concepts of the application. The input of the conceptual model is designed as an iterative and assisted process using two main knowledge sources, which are the generic grammar 11 and the basic vocabulary 12.

One way of implementing the derivation means 3 is to extend a syntactic and semantic grammar so as to enable conceptual constraints to be taken into account. It thus becomes possible to define, within this high level formalism, a generic grammar, which is adapted to the applied field automatically through data input by the operator. The derivation means can thus be used to compute the syntactic/semantic grammar and the vocabulary specific to the applied field. Thus, as diagrammatically represented in FIG. 2, the device uses the conceptual model 8 input by the operator to deduce the linguistic model which it transmits to the derivation means 13. It is essential to note here that the conceptual model is used not only to compute the linguistic model and the sub-models linked to it (linguistic model for recognition, linguistic model for analysis and linguistic model for generation), but is also used to manage the operator-system dialog for everything to do with reference to the concepts and the objects of the application.

The revision-explanation means 14, for their revision function, are accessible via the graphical interface 7 for inputting the conceptual model of the application. They use a grammar generator 15 which computes the grammar corresponding to the model entered and offers mechanisms for displaying all or some of the corresponding statements. To this end, the grammar generator 15 comprises a syntactic and semantic grammar 16 for analyzing statements, a grammar 17 for generating statements and a grammar 18 for voice recognition.

The revision-explanation means 14, for their explanation function, are based on a formal analysis of the computation done by the derivation means 13 to identify the data from which the characteristics of these statements originate. These means are used by the operator to design his model iteratively while checking that the statements that will be produced correctly meet his expectations.

FIG. 3 details an exemplary embodiment of the execution means 6 of the voice interface. These means comprise:
a speech recognition device 19, which uses the grammar 18 derived from the linguistic model automatically;
a statement analyzer 20 which uses the linguistic model provided by the derivation means 13. It syntactically and semantically checks the accuracy of the statements;
a dialog processor 21 which uses the conceptual model input by the operator, as well as the database 9 of the linguistic entities of the application, input by the operator or constructed automatically by the application 22;
a statement generator 23, which uses the statement generation grammar 17 derived from the linguistic model automatically;
a speech synthesis device 24.

The set of elements 19 to 21 and 23, 24 for executing the voice interface is managed in the present case by a multi-agent type system 25.

There now follows an explanation of the implementation of the input means, the revision means and the explanation means using a very simple example.

A) Input Means

In order to make accessible to voice the concepts of television channel (CHANNEL), televized programme (PROGRAMME), movie (MOVIE), cartoon (CARTOON), and the fact that a television channel plays (PLAY) televized programmes, the input means must first be used to describe the vocabulary, relating to the concepts, that is to be taken into account.

Firstly, the input means are used to help the designer of the voice interface when compiling the vocabulary. For this, mechanisms are provided to propose, for a given term (for example “movie” for the English version of the vocabulary and “film” for the French version), all the inflected forms corresponding to this term (singular and plural of a common name or conjugations of a verb, for example). The designer of the vocabulary therefore only has to select from all these forms, those that he wants to find in the voice interface.

The concepts that must be accessible to voice are then created via these same input means. In the present case, this means creating CHANNEL, PROGRAMME, MOVIE and CARTOON entities, and a PLAY relationship. These concepts are linked to a set of terms in the vocabulary. Thus, the MOVIE concept will be linked to the terms “movie”, “movies”, “film” and “films”. These links can be used to create a certain number of clauses used by the derivation means:
entity ([CARTOON, [cartoon]])
entity ([MOVIE, [movie]])
entity ([PROGRAMME, [programme]])
entity ([CHANNEL, [channel 5, cnn]])
etc.

For the PLAY relationship, it is essential to explain the parties involved in this relationship: the televised channel and the programme. This gives rise to another type of clause intended for the derivation means:
functional_structure ([PLAY, Subject (CHANNEL), DirectObject (PROGRAMME), [play]]).

The input means are then used to explain a certain number of additional relationships between these concepts. For example, a movie is a type of televised programme. The consequence of these relationships will be to create other clauses used by the derivation means:
is_a (MOVIE, PROGRAMME)
etc.

The provision of these input means primarily facilitates the input of the specific resources needed to implement the voice interface. In practice, this input is largely carried out by selecting certain criteria from a set of criteria proposed via a graphical interface. The file of resources (clauses) needed by the derivation means is generated automatically from this graphical representation of the set of criteria chosen. This enables the designer of the voice interface to avoid making syntax errors in the resource file, and omissions.

B) Revision Means

The revision means are used by the designer of the voice interface to validate or correct the conceptual model that has been created via the input means.

A first step of the revision procedure consists in displaying all or some of the phraseology corresponding to the conceptual model.

In the present example, the following phrases could be displayed:
1) A movie
2) A cartoon
3) A movie plays Channel 5
4) etc

The sentence “a movie plays Channel 5” is incorrect. The explanation means reveal that this error originates from the fact that the PLAY relationship has been badly defined:
functional_structure ([PLAY, Subject (PROGRAMME), DirectObject (CHANNEL), [play]]).
PROGRAMME acts as the subject

Instead of:
functional_structure (PLAY, Subject (CHANNEL), DirectObject (PROGRAMME), [play]]).
   CHANNEL acts as the subject

The revision means are used by the designer of the voice interface to display this error, and to modify the conceptual model in order to correct it.

C) Explanation Means

The purpose of the explanation means is to identify and to describe the subset or characteristic of the conceptual model whose compilation produces the sub-grammar corresponding to a particular statement, to a particular linguistic expression—a statement portion—or to a particular linguistic property—an expression characteristic.

Thus, the explanation means enable the user, by selecting a statement, an expression or a property generated by the grammar, to find and understand the subset or the characteristic of the conceptual model from which it originates.

Then, he can modify the conceptual model to modify the statement, the expression or the generated property and, by reiterating the procedure, refine the conceptual model in order to obtain the grammar of the required language.

As an example, the possibility of using the plural in the relationship between the unit entity and the mission entity in the following four expressions depends on the cardinality of this relationship.
1. “the mission of the unit”
2. “the missions of the unit”
3. “the mission of the units”
4. “the missions of the units”

The relationship in question is described by the following conceptual rule:
entity (unit, relationship (mission, X, Y)

If X=1 and Y=1, only the expression 1. is allowed by the grammar. If X=1 and Y=n, only the expressions 1. and 2. are allowed by the grammar. If X=n and Y=1, only the expressions 1. and 3. are allowed by the grammar. Finally, if X=n and Y=n, all the expressions are allowed by the grammar (n≧2).

In this example, the explanation means must allow the user to identify the fact that the cardinality of the conceptual rule must be modified to obtain the grammar corresponding to the plural expressions that he wants included in his language.

An embodiment of the explanation means consists in constructing a backtracking analysis method on the grammar compilation method, which will make it possible to start from the result to find the conceptual rules that culminate in this result and, consequently, describe them to the user.

1. A generic method for automatic production of voice recognition interfaces for an applied field, comprising the steps of:
inputting a conceptual model of the applied voice interface field,
producing a set of generic grammar rules representative of a class of applications, exemplifying different generic grammar rules whose constraints are satisfied producing grammar for the applied field concerned from the exemplified generic grammar and from a conceptual model.

2. The method as claimed in claim 1, wherein the data input is revised and the terms contrary to the semantics of the application concerned are corrected.

3. The method as claimed in claim 1, wherein the data input is revised and that new terms are added to enrich the grammar of the applied field.

4. The method as claimed in claim 1, wherein that explanations are produced, explaining the rules that were applied when generating the grammar specific to the applied field.

5. A device for automatic production of voice recognition interfaces for an applied field, comprising:
conceptual model input means,
derivation means,
means of providing a generic model and
means of executing the grammar specific to the applied field concerned.

6. The device as claimed in claim 5, wherein further comprising revision means.

7. The device as claimed in claim 5, wherein further comprising explanation means.

8. The method as claimed in claim 2, wherein the data input is revised and new terms are added to enrich the grammar of the applied field.

9. The method as claimed in claim 2, wherein explanations are produced, explaining the rules that were applied when generating the grammar specific to the applied field.

10. The method as claimed in claim 3, wherein explanations are produced, explaining the rules that were applied when generating the grammar specific to the applied field.

11. The method as claimed in claim 4, wherein explanations are produced, explaining the rules that were applied when generating the grammar specific to the applied field.

12. The device as claimed in claim 6, wherein it further comprising explanation means.
